(19) United States
(12) Patent Application Publication
(10) Pub. No.: US 2019/0097467 A1
(43) Pub. Date: Mar. 28, 2019

(54) POWER FEEDER AND POWER FEEDING SYSTEM

(71) Applicant: SONY CORPORATION, TOKYO (JP)

(72) Inventor: KUNIYA ABE, KANAGAWA (JP)

(21) Appl. No.: 16/199,280

(22) Filed: Nov. 26, 2018

Related U.S. Application Data
(63) Continuation of application No. 13/137,731, filed on Sep. 8, 2011.

(30) Foreign Application Priority Data
Oct. 8, 2010 (JP) 2010-228883

(51) Int. Cl. H02J 50/40; H02J 7/02; H02J 50/12

(52) U.S. Cl. CPC H02J 50/40; H02J 50/12; H02J 7/025; Y10T 307/25

(57) ABSTRACT

Disclosed herein is a power feeder including: a power transmission section adapted to transmit power to one or a plurality of electronic devices using a magnetic field; and a control section adapted to control the operation of the power transmission section, wherein the control section controls the operation of the power transmission section in such a manner as to transmit power in a condition relatively away from a maximum condition in which the transmission efficiency is maximal in an initial operation period as compared to a stable operation period that follows during power transmission.

### CROSS REFERENCE TO RELATED APPLICATIONS

The present application is a continuation application of U.S. patent application Ser. No. 13/137,731, filed Sep. 8, 2011, which claims the priority from prior Japanese Priority Patent Application JP 2010-228883 filed in the Japan Patent Office on Oct. 8, 2010, the entire content of which is hereby incorporated by reference.

### BACKGROUND

The present disclosure relates to a power feeder for supplying (transmitting) power in a noncontact manner to an electronic device such as mobile phone and a power feeding system using the same.

Recent years have seen attention focused on power feeders (noncontact chargers or wireless chargers) adapted to supply power in a noncontact manner to CE devices (Consumer Electronics Devices) such as mobile phones and portable music players (e.g., Japanese Patent Laid-Open Nos. 2001-102974, 2008-206233, 2002-34169, 2005-110399, and 2010-63245, and PCT Patent Publication No. WO00-27531) by using, for example, electromagnetic induction or magnetic resonance. As a result, the charging can be initiated simply by placing an electronic device on a charging tray rather than inserting (connecting) the connector of the power supply device similar to an AC adapter into (to) the electronic device. That is, terminal connection is not necessary between the electronic device and charging tray.

### SUMMARY

Incidentally, noncontact power feeders as those described above (in particular, those using magnetic resonance) are restricted in terms of the operating conditions to transmit power in a highly efficient manner, occasionally resulting in improper operation. More specifically, the power feeders in related art are designed to provide improved transmission efficiency in steady-state operation (stable operation). This leads, from time to time, to failure of the electronic device to operate properly at the time of activation (at the time of initial activation) depending on the type and condition of the electronic device serving as a load, making it difficult to supply power properly.

Because of the above, a proposal of a method has been hoped for that would achieve proper supply of power tailored to a variety of loads (targets to be powered such as electronic devices) during power transmission using a magnetic field.

The present disclosure has been made in light of the foregoing, and it is desirable to provide a power feeder and power feeding system that can properly supply power in a manner tailored to a variety of loads during power transmission using a magnetic field.

A power feeder according to the embodiment of the present disclosure includes a power transmission section and control section. The power transmission section transmits power to one or a plurality of electronic devices using a magnetic field. The control section controls the operation of the power transmission section. The control section controls the operation of the power transmission section in such a manner as to transmit power in a condition relatively away from a maximum condition in which the transmission efficiency is maximal in an initial operation period as compared to a stable operation period that follows during power transmission.

A power feeding system according to the embodiment of the present disclosure includes one or a plurality of electronic devices and the power feeder according to the embodiment of the present disclosure adapted to transmit power to the electronic devices.

In the power feeder and power feeding system according to the embodiment of the present disclosure, the power transmission section is controlled in such a manner as to transmit power in a condition relatively away from the maximum condition in which the transmission efficiency is maximal in an initial operation period as compared to a stable operation period that follows during power transmission to an electronic device using a magnetic field. This makes it possible to avoid activation failure of the electronic device (failure to transmit sufficient power to activate the electronic device) in the initial operation period (activation period) while at the same time achieving high transmission efficiency (transmitting power with high efficiency) in the stable operation period.

In the power feeder and power feeding system according to the embodiment of the present disclosure, the power transmission section is controlled in such a manner as to transmit power in a condition relatively away from the maximum condition in which the transmission efficiency is maximal in the initial operation period as compared to the stable operation period that follows during power transmission to an electronic device using a magnetic field. This makes it possible to avoid activation failure of the electronic device in the initial operation period while at the same time achieving highly efficient power transmission in the stable operation period. As a result, power can be transmitted properly in a manner tailored to a variety of loads (targets to be powered such as electronic devices) during power transmission using a magnetic field.

### BRIEF DESCRIPTION OF THE DRAWINGS

FIG. 1 is a block diagram illustrating an example of overall configuration of a power feeding system according to an embodiment of the present disclosure;

FIG. 2 is a characteristic diagram illustrating an example of relationship between an initial operation period and stable operation period and power during supply of power (charging);

FIGS. 3A and 3B are schematic block diagrams for describing the power supply operation (charging operation) in the initial operation period and stable operation period;

FIG. 4 is a flowchart illustrating an example of a control method of the charging operation; and

FIG. 5 is a characteristic diagram for describing the example of the control method of the charging operation.

### DETAILED DESCRIPTION OF THE PREFERRED EMBODIMENT

A detailed description will be given below of the preferred embodiment of the present disclosure with reference to the accompanying drawings. It should be noted that the description will be given in the following order.

1. Embodiment (example in which the power feeding system includes the power feeder and one electronic device)
2. Modification example

### EMBODIMENT

### [Configuration of a Power Feeding System 3]

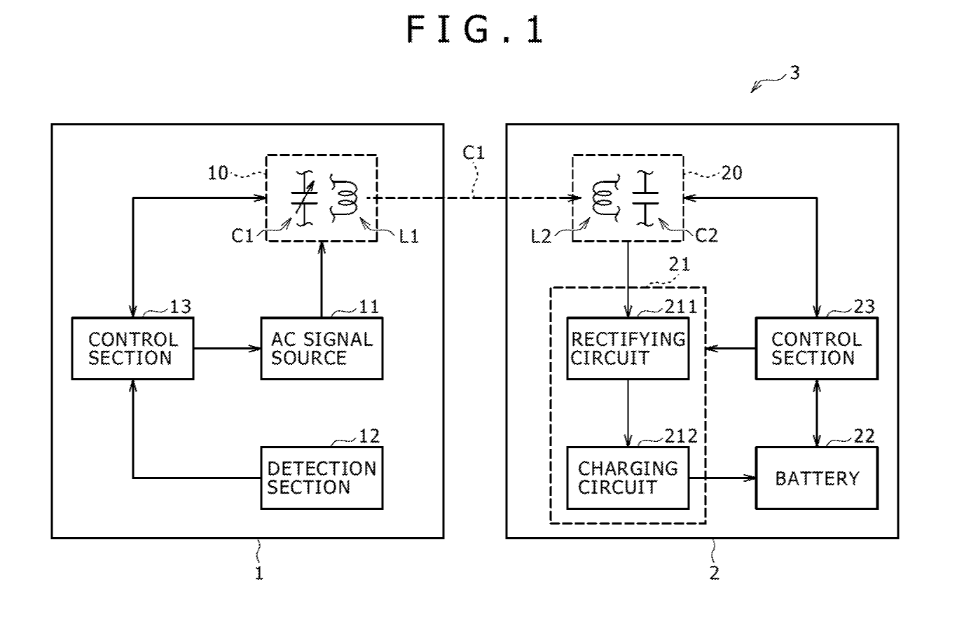

FIG. 1 is a block diagram illustrating an example of overall configuration of a power feeding system according to an embodiment of the present disclosure (power feeding system 3). The power feeding system 3 is designed to transmit power (supply or feed power) in a noncontact manner by using a magnetic field (using, for example, electromagnetic induction or magnetic resonance; the same holds true hereinafter). The power feeding system 3 includes a charging tray (power feeder) 1 (primary device) and an electronic device 2 (secondary device). That is, in the power feeding system 3, power is transmitted from the charging tray 1 to the electronic device 2 when the electronic device 2 is placed on (or in proximity to) the charging tray 1. In other words, the power feeding system 3 is a noncontact power feeding system.

### (Charging Tray 1)

The charging tray 1 is a power feeder designed to transmit power to the electronic device 2 using a magnetic field as described above. The same tray 1 includes a power transmission section 10, AC signal source 11, detection section 12 and control section 13.

The power transmission section 10 includes a coil (primary coil) L1 and capacitive element (variable capacitive element) C1. The same section 10 is designed to achieve magnetic field-based power transmission to the electronic device 2 (more specifically, a power receiving section 20 which will be described later) using the coil L1 and capacitive element C1. More specifically, the power transmission section 10 is capable of radiating a magnetic field (magnetic flux) to the electronic device 2. It should be noted that the same section 10 may exchange a predetermined signal with the electronic device 2.

The AC signal source 11 includes, for example, an AC power source, oscillator and amplifier and supplies a predetermined AC signal (AC signal frequency=f1 in this case) for power transmission to the coil L1 and capacitive element C1 of the power transmission section 10.

The detection section 12 performs a detection operation which is used as determination criteria for control exercised by the control section 13 which will be described later. More specifically, the detection section 12 detects, in an initial operation period T1 during power transmission which will be described later, at least either an impedance Z of the power transmission section 10 or electronic device 2 (power receiving section 20) or wattage (power P) during power transmission. The detection section 12 also detects at least one of the impedance Z, and the wattage (power P) and a reflectance R during power transmission in a stable operation period T2 during power transmission which will be described later (period following the initial operation period T1). It should be noted that the detection operation by the detection section 12 will be described in detail later.

The control section 13 controls the operation of the charging tray 1 as a whole and includes, for example, a microcomputer. The same section 13 controls the operation of the power transmission section 10 and AC signal source 11 in such a manner as to transmit power in a condition relatively away from the maximum condition in which the transmission efficiency is maximal in the initial operation period T1 as compared to the stable operation period T2 that follows during power transmission. More specifically, the control section 13 controls the operation of the power transmission section 10 and AC signal source 11 according to the detection result obtained by the detection section 12. It should be noted that the control operation performed by the control section 13 will be described in detail later.

### (Electronic Device 2)

The electronic device 2 includes the power receiving section 20, a charging section 21, battery 22 and control section 23.

The power receiving section 20 includes a coil (secondary coil) L2 and capacitive element C2. The same section 20 is capable of receiving power from the power transmission section 10 of the charging tray 1 using the coil L2 and capacitive element C2. It should be noted that the same section 20 may exchange a predetermined signal with the charging tray 1.

The charging section 21 includes a rectifying circuit 211 and charging circuit 212 and charges the battery 22 based on power (AC power) received by the power receiving section 20. More specifically, the rectifying circuit 211 rectifies the AC power, supplied from the power receiving section 20, into DC power. The charging circuit 212 charges the battery 22 based on the DC power supplied from the rectifying circuit 211.

The battery 22 stores power according to the level of charge delivered by the charging circuit 212 and includes, for example, a secondary battery such as lithium-ion battery.

The control section 23 controls the operation of the electronic device 2 as a whole and includes, for example, a microcomputer. More specifically, the control section 23 controls the operation of the power receiving section 20, charging section 21 and battery 22.

### [Operation and Effect of the Power Feeding System 3]

### (1. Outline of the Charging Operation)

In the charging tray 1 of the power feeding system 3 according to the present embodiment, the AC signal source 11 supplies a predetermined AC signal (AC signal frequency=f1 in this case) for power transmission to the coil L1 and capacitive element C1 of the power transmission section 10 according to control exercised by the control section 13. This generates a magnetic field (magnetic flux) in the coil L1 of the power transmission section 10. At this time, when the electronic device 2 is placed on (or in proximity to) the top surface (power transmission surface) of the charging tray 1 as a target to be powered (target to be charged), the coil L1 in the charging tray 1 and the coil L2 in the electronic device 2 are brought in proximity to each other near the top surface of the charging tray 1.

As described above, when the coil L2 is placed in proximity to the coil L1 that generates a magnetic field (magnetic flux), an electromotive force is generated in the coil L2 as a result of induction by the magnetic flux generated in the coil L1. In other words, electromagnetic induction or magnetic resonance generates magnetic fluxes, each interlinked with one of the coils L1 and L2, allowing power to be transmitted from the side of the coil L1 (side of the charging tray 1 and power transmission section 10) to the side of the coil L2 (side of the electronic device 2 and power receiving section 20).

As a result, in the electronic device 2, the AC power received by the coil L2 is supplied to the charging section 21, thus allowing for the battery 22 to be charged as described below. That is, this AC power is converted into DC power by the rectifying circuit 211, after which the battery 22 is charged by the charging circuit 212 based on the DC power. As described above, the electronic device 2 is charged based on the power received by the power receiving section 20.

That is, in the present embodiment, terminal connection using, for example, an AC adapter is not necessary to charge the electronic device 2. The electronic device 2 can be readily charged (power can be fed to the electronic device 2 in a noncontact manner) simply by placing the same device 2 on (or in proximity to) the top surface of the charging tray 1. This contributes to reduced burden on the part of the user.

### (2. Control Method During the Charging Operation)

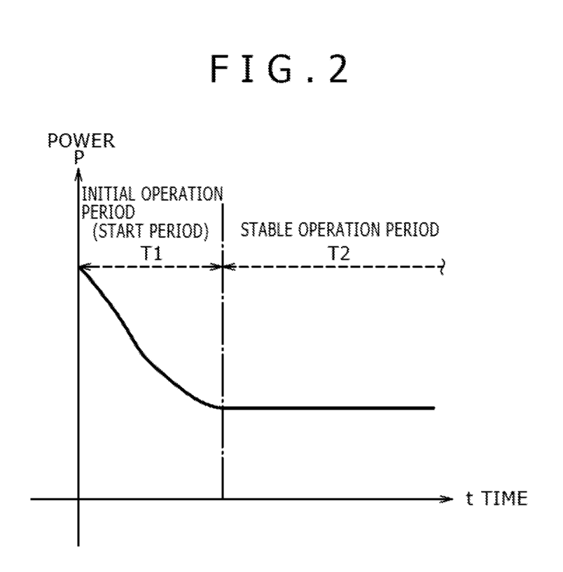

Incidentally, noncontact power feeders in related art (in particular, those using magnetic resonance) are restricted in terms of the operating conditions to transmit power in a highly efficient manner, occasionally resulting in improper operation. More specifically, first, the load may change steeply between the period of activation (initial operation period (activation period) T1) and the period of stable operation (period of steady-state operation) (stable operation period T2) depending on the type and condition of the electronic device serving as a target to be powered (load) as illustrated, for example, in FIG. 2. That is, the power P is high because the load is large in the initial operation period T1. The power P declines steeply, converging to a constant value (steady-state value) in the stable operation period T2.

Here, the power feeders in related art are designed to provide improved transmission efficiency in the stable operation period T2. This leads, from time to time, to failure of the electronic device to operate properly in the initial operation period T1 depending on the type and condition of the electronic device serving as a load, making it difficult to supply power properly.

In the power feeding system 3 according to the present embodiment, therefore, the control section 13 of the charging tray 1 exercises control in the following manner. That is, the control section 13 controls the operation of the power transmission section 10 and AC signal source 11 in such a manner as to transmit power in a condition relatively away (deviated or far) from the maximum condition in which the transmission efficiency is maximal in the initial operation period T1 as compared to the stable operation period T2 that follows during power transmission. More specifically, the control section 13 changes at least one of four parameters, namely, an inductance L of the coil L1, a capacitance C of the capacitive element C2, a voltage V1 and the frequency f1 during power transmission, thus controlling the operation of the power transmission section 10 and so on.

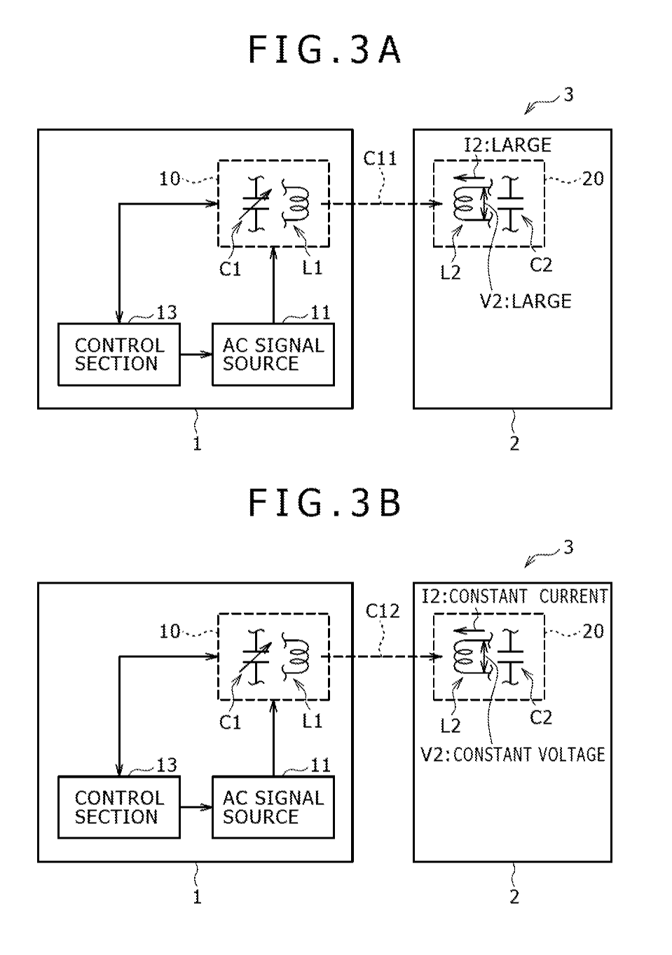

More specifically, the control section 13 exercises control so that the smallest possible power that can activate the electronic device 2 is transmitted in the initial operation period T1 shown in FIG. 3A (refer to reference numeral C11 in FIG. 3A). That is, the above parameters are changed so that a current I2 flowing through the coil L2 of the electronic device 2 and a voltage V2 across the coil L2 are larger as illustrated in FIG. 3A. In other words, these parameters (e.g., capacitance C and inductance L) are changed so as to transmit power under an impedance mismatched condition.

In the stable operation period T2 shown in FIG. 3B, on the other hand, the control section 13 exercises control so that power is transmitted with higher efficiency (higher efficiency is achieved) than in the initial operation period T1. The control section 13 should preferably exercise control in a manner intended for the stable operation period T2 so that power is transmitted in the maximum condition in which the transmission efficiency is maximal (refer to reference numeral C12 in FIG. 3B). That is, as illustrated in FIG. 3B, the above parameters are changed so that the current I2 or voltage V2 is constant (steady-state value smaller than that in the initial operation period T1).

As described above, in the present embodiment, the control section 13 of the charging tray 1 controls the operation of the power transmission section 10 and AC signal source 11 during power transmission from the charging tray 1 to the electronic device 2. More specifically, the control section 13 controls the operation of the power transmission section 10 and so on in such a manner as to transmit power in a condition relatively away from the maximum condition in which the transmission efficiency is maximal in the initial operation period T1 as compared to the stable operation period T2 that follows. This makes it possible to avoid activation failure of the electronic device 2 (failure to transmit power sufficient to activate the electronic device 2) in the initial operation period (activation period) T1 while at the same time achieving high transmission efficiency (transmitting power with high efficiency) in the stable operation period T2. A more detailed description will be given below of control exercise by the control section 13.

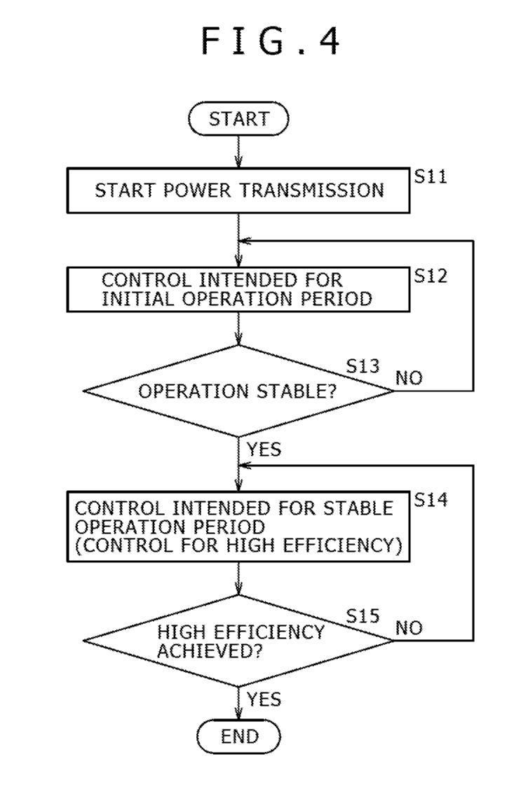

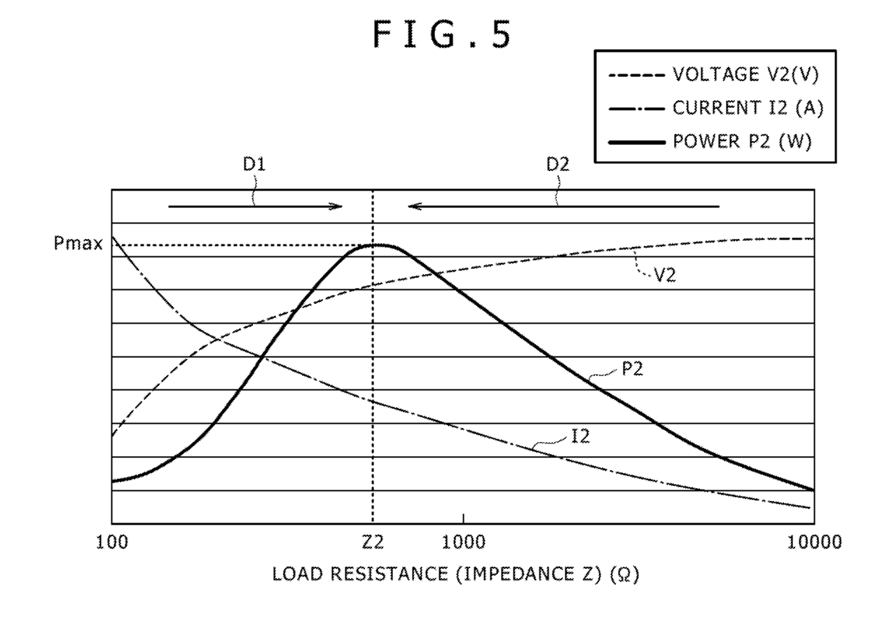

FIG. 4 is a flowchart illustrating an example of a control method of the charging operation (power supply operation) according to the present embodiment (control method used by the control section 13). On the other hand, FIG. 5 is a characteristic diagram for describing the example of the control method according to the present embodiment. FIG. 5 illustrates an example of relationship between the load resistance (impedance Z) and the voltage V2, current I2 and power P2 (=V2×I2) in the electronic device 2.

First, the control section 13 controls the operation of the power transmission section 10 and AC signal source 11 in such a manner as to start power transmission from the charging tray 1 to the electronic device 2 (step S11 in FIG. 4).

Next, the control section 13 exercises control in the initial operation period T1 as described above (step S12). More specifically, the control section 13 controls the operation of the power transmission section 10 and AC signal source 11 so that the smallest possible power that can activate the electronic device 2 is transmitted in the initial operation period T1. More specifically, the control section 13 changes at least one of the four parameters, namely, the inductance L of the coil L1, the capacitance C of the capacitive element C2, and the voltage V1 and frequency f1 during power transmission, thus controlling the operation of the power transmission section 10 and so on. Further, the control section 13 changes the above parameters based on the detection results obtained by the detection section 12 (at least one of the two detection results, i.e., the impedance Z of the power transmission section 10 or electronic device 2 (power receiving section 20) and wattage (power P) during power transmission).

More specifically, as illustrated, for example, in FIG. 5, the control section 13 exercises control so that power is transmitted in a condition relatively away from the condition in which the power P2 is equal to a maximal value Pmax (impedance Z=Z2) (maximum condition in which the transmission efficiency is maximal). That is, the control section 13 exercises control here so that the impedance Z is away from Z2 (value at the left- or right-edge in FIG. 5 (smaller or larger)). It should be noted here that when Z«Z2, the current I2 tends to be relatively large as compared to the voltage V2 and that when Z»Z2, the voltage V2 tends to be relatively large as compared to the current I2.

Next, the control section 13 determines whether the power transmission operation has stabilized (whether the initial operation period T1 has changed to the stable operation period T2) (step S13). More specifically, the control section 13 makes this determination based on the detection results obtained by the detection section 12 (detection results of the impedance Z and power P described above). If the control section 13 determines that the power transmission operation has yet to stabilize (the initial operation period T1 has yet to change to the stable operation period T2) (N in step S13), the process returns to step S12. It should be noted that this determination may be made based on whether a predetermined amount of time has elapsed rather than based on the detection results obtained by the detection section 12.

On the other hand, when the control section 13 determines that the power transmission operation has stabilized (the initial operation period T1 has changed to the stable operation period T2) (Y in step S13), the same section 13 exercises control in a manner intended for the stable operation period T2 (control for high efficiency) (step 14). More specifically, the control section 13 controls the power transmission section 10 and AC signal source 11 in such a manner as to achieve higher transmission efficiency in the stable operation period T2 than in the initial operation period T1. Further, the control section 13 should preferably exercise control so that power is transmitted in the maximum condition in which the transmission efficiency is maximal. More specifically, the control section 13 changes at least one of the four parameters, namely, the inductance L of the coil L1, the capacitance C of the capacitive element C2, and the voltage V1 and frequency f1 during power transmission as it does in the initial operation period T1, thus controlling the operation of the power transmission section 10 and so on. On the other hand, the control section 13 changes the above parameters based on the detection results obtained by the detection section 12 (at least one of the impedance Z, and the wattage (power P) and reflectance R during power transmission).

More specifically, the control section 13 exercises control so that power is transmitted in a condition relatively away from the condition in which the power P2 is equal to the maximal value Pmax (impedance Z=Z2) (maximum condition in which the transmission efficiency is maximal). Further, the control section 13 should preferably exercise control so that power is transmitted in the condition in which the power P2 is equal to the maximal value Pmax (impedance Z=Z2) (maximum condition) as described above.

Next, the control section 13 determines whether high efficiency has been achieved (whether the operation in the stable operation period T2 is completed) (step S15). More specifically, the control section 13 makes this determination based on the detection results obtained by the detection section 12 (detection results of the impedance Z and power P described above). If the same section 13 determines that high efficiency has yet to be achieved (N in step S15), the process returns to step S14.

On the other hand, when the same section 13 determines that high efficiency has been achieved (Y in step S15), the entire control procedure shown in FIG. 4 is terminated.

As described above, in the present embodiment, the control section 13 controls the operation of the power transmission section 10 and so on in such a manner as to transmit power in a condition relatively away from the maximum condition in which the transmission efficiency is maximal in the initial operation period T1 as compared to the stable operation period T2 that follows during power transmission from the charging tray 1 to the electronic device 2 using a magnetic field. This makes it possible to avoid activation failure of the electronic device 2 in the initial operation period T1 while at the same time transmitting power with high efficiency in the stable operation period T2. As a result, power can be transmitted properly in a manner tailored to a variety of loads (targets to be powered such as electronic devices) during power transmission using a magnetic field.

Even if, for example, the components of the power receiving section 20 change because of the customizing of the electronic device 2 serving as a target to be powered, the technique according to the present embodiment eliminates the need to consider fitting of the components.

### Modification Example

Although described by way of the preferred embodiment, the present disclosure is not limited thereto but may be modified in various ways.

For example, although, in the above embodiment, the control method of the charging operation (power supply operation) by the control section 13 has been described, the control method is not limited thereto, and the charging operation may be controlled by other control method.

Further, although, in the above embodiment, a description has been given by naming specific components of the charging tray and electronic device, there is no need for the charging tray and electronic device to include all the components. Alternatively, the charging tray and electronic device may include other components.

Still further, although, in the above embodiment, a description has been given of a case in which only one electronic device is provided in the power feeding system, the power feeding system according to the embodiment of the present disclosure is also applicable to a case in which a plurality of (two or more) electronic devices are provided.

In addition, although, in the above embodiment, the charging tray 1 for a small-size electronic device (CE device) such as mobile phone has been taken as an example of the power feeder according to the embodiment of the present disclosure, the power feeder according to the embodiment of the present disclosure is not limited in use to the charging tray 1 for home use but is applicable as a charger for a variety of electronic devices. Further, it is not necessary for the power feeder according to the embodiment of the present disclosure to be a tray. Instead, the power feeder according to the embodiment of the present disclosure may be, for example, a stand such as so-called cradle for electronic devices.

The present disclosure contains subject matter related to that disclosed in Japanese Priority Patent Application JP 2010-228883 filed in the Japan Patent Office on Oct. 8, 2010, the entire content of which is hereby incorporated by reference.

It should be understood by those skilled in the art that various modifications, combinations, sub-combinations and alterations may occur depending on design requirements and other factors in so far as they are within the scope of the appended claims or the equivalents thereof.

What is claimed is:

1. A power feeder, comprising:
a power transmission section adapted to transmit power to one or a plurality of electronic devices using a magnetic field; and
a control section adapted to control the operation of the power transmission section, wherein
the control section controls the operation of the power transmission section in such a manner as to transmit power in a condition relatively away from a maximum condition in which the transmission efficiency is maximal in an initial operation period as compared to a stable operation period that follows during power transmission.

2. The power feeder of claim 1, wherein
the control section exercises control in the initial operation period so that the smallest possible power that can activate the electronic device is transmitted, and
the control section exercises control in the stable operation period so that power is transmitted with higher efficiency than in the initial operation period.

3. The power feeder of claim 2, wherein
the control section exercises control in the stable operation period so that power is transmitted in the maximum condition.

4. The power feeder of claim 1, wherein
the power transmission section has a coil and capacitive element, and
the control section changes at least one of four parameters, namely, an inductance of the coil, a capacitance of the capacitive element, a voltage and frequency during the power transmission so as to control the operation of the power transmission section.

5. The power feeder of claim 4, wherein
the control section changes at least one of the parameters based on at least one of two detection results, i.e., an impedance of the power transmission section or electronic device and a wattage during the power transmission, in the initial operation period.

6. The power feeder of claim 4, wherein
the control section changes at least one of the parameters based on at least one of three detection results, i.e., the impedance of the power transmission section or electronic device, the wattage and a reflectance during the power transmission, in the stable operation period.

7. A power feeding system, comprising:
one or a plurality of electronic devices; and
a power feeder adapted to transmit power to the electronic devices, wherein
the power feeder includes
a power transmission section adapted to transmit power using a magnetic field, and
a control section adapted to control the operation of the power transmission section,
the control section controlling the operation of the power transmission section in such a manner as to transmit power in a condition relatively away from a maximum condition in which the transmission efficiency is maximal in an initial operation period as compared to a stable operation period that follows during the power transmission.
